(19) United States
(12) Patent Application Publication
(10) Pub. No.: US 2024/0100745 A1
(43) Pub. Date: Mar. 28, 2024

(54) METHOD AND APPARATUS FOR PROCESSING, BY MEANS OF RECYCLING, A WORKPIECE MADE OF ELECTROPLATED PLASTIC

(71) Applicant: ImpulsTec GmbH, Radebeul (DE)

(72) Inventor: Stefan Eisert, Wehrsdorf (DE)

(21) Appl. No.: 18/527,605

(22) Filed: Dec. 4, 2023

Related U.S. Application Data
(63) Continuation of application No. PCT/EP2022/063915, filed on May 23, 2022.

(30) Foreign Application Priority Data
Jun. 2, 2021 (DE) 10 2021 205 637.7

(51) Int. Cl. B29B 17/02; B02C 19/18; B02C 23/10; B29B 17/04

(52) U.S. Cl. CPC B29B 17/02; B02C 19/18; B02C 23/10; B29B 17/0412; B02C 2019/183; B29B 2017/0272

(57) ABSTRACT

A method for processing, namely recycling, a workpiece made of electroplated plastic. In which method a coating is removed from the workpiece by a fragmentation unit by applying the electrohydraulic effect to a suspension containing plastic granules and containing coating granules. The suspension is dewatered, and a magnetic separator is used to separate the plastic granules from the coating granules by means of magnetic separation.

### CROSS-REFERENCE TO RELATED APPLICATION

This application is a continuation, under 35 U.S.C. § 120, of copending International Patent Application PCT/EP2022/063915, filed May 23, 2022, which designated the United States; this application also claims the priority, under 35 U.S.C. § 119, of German Patent Application DE 10 2021 205 637.7, filed Jun. 2, 2021; the prior applications are herewith incorporated by reference in their entireties.

### FIELD AND BACKGROUND OF THE INVENTION

The invention relates to a method and to an apparatus for processing by recycling a workpiece composed of galvanized plastic. The invention further relates to a use of the electrohydraulic effect for delamination of a workpiece composed of galvanized plastic.

Workpieces made of plastic are nowadays used in a variety of applications, for example because of their low weight, chemical stability, and easy and inexpensive production by injection molding. In order to improve the optical, electrical, mechanical or thermal properties, it is possible to coat the plastic with a metal.

Plastics can be coated with metals, for example, by means of galvanic deposition, which is also referred to as plastic galvanization or plating on plastics (POP). Plastics are typically not electrically conductive, and so the plastic surface first has to be coated with an electrically conductive layer having good adhesion for subsequent electrolytic coating.

Because of the resulting good adhesion of the metal layer on the plastic material, recycling, or processing by recycling, of galvanized plastics is comparatively complex and costly. In particular, a comparatively high quality and purity is required in secondary plastics, i.e. recycled plastics, in order to make them utilizable as substitute for primary plastics. It has not been possible to date to delaminate electroplated products or galvanized plastics by a purely mechanical route without loss of quality of the recycled plastic (downcycling), such that the secondary plastics generally do not meet quality demands for recycling of plastics. There is therefore a need for an efficient recycling solution for effective utilization of plastic raw materials, and to be able to return them to production rather than dispose of them with inferior value.

Published, non-prosecuted German patent application DE 10 237 960 A1 describes gradated etching of an electroplated layer of a galvanized plastic part by means of hydrochloric acid, hydrogen peroxide and sulfuric acid. This process very substantially consumes the hydrogen peroxide and sulfuric acid chemicals used, and requires subsequent polymer washing and drying. Moreover, the use of acid leads to damage to the polymer structure of the plastic and reduces the material value of the recyclate. The known demetallization process attacks the plastic so severely that it cannot be reused in electroplating. The recycling products of such a process can therefore be used only for low-value applications.

European patent EP 2 771 120 B1, corresponding to U.S. Pat. No. 10,399,085, discloses a method and an apparatus for material-selective breakdown of a recycled material into reutilizable materials by means of the electrohydraulic effect, in which a shock discharge with a discharge energy between 200 J (joules) and 1500 J per electrode is generated, essentially in the liquid, between an electrode on the vessel base and a number of electrodes disposed on the vessel lid. The average electrical field strength here is less than 5 kV/mm (kilovolts per millimeter) and the repetition rate of the high-voltage pulses is less than 10 Hz (hertz). What are specifically described are the applications of the method and of the apparatus to scrap electronics, coated metal foils, printed circuit boards and accumulators.

International patent disclosure WO 2017/037129 A1 describes a method of recycling composite materials composed of glass-semiconductor polymer composites, in which the glass component is separated by means of the electrohydraulic effect. Shock discharges are envisaged here with a discharge energy between 200 J and 1500 J per electrode and high voltage in the range between 30 kV (kilovolts) and 50 kV, and repetition rates of the high-voltage pulses of less than 10 Hz.

International patent disclosure WO 2019/234109 A1 discloses a process and an apparatus for comminution and breakdown of a material by means of the electrohydraulic effect. The shock discharges used here have a discharge energy of less than 100 J and high voltages in the range between 30 kV and 50 kV, and repetition rates of the high-voltage pulses between 20 Hz and 100 Hz. Application here is effected in the case of brittle materials or products having brittle constituents, especially silicates, ceramic, silicon, silicon carbide, materials having high purity requirements, especially glass, ceramics, semiconductor material, glass-polymer composites, especially solar modules, composite safety glass, and/or metallurgical slags.

### SUMMARY OF THE INVENTION

It is an object of the invention to specify a particularly suitable method of processing by recycling of a workpiece composed of galvanized plastic. In particular, the target parameter for the further processing is to achieve plastic pellets having maximum purity and quality. It is a further object of the invention to specify a particularly suitable apparatus for performance of the method.

With regard to the method, the object is achieved in accordance with the invention by the features of the independent method claim, and with regard to the apparatus by the features of the independent apparatus claim, and with regard to the use by the features of the independent use claim. Advantageous configurations and developments are the subject of the dependent claims. The advantages and configurations cited with regard to the method are also applicable mutatis mutandis to the apparatus, and vice versa.

Where method steps are described hereinafter, advantageous configurations in respect of the apparatus arise in particular in that the apparatus is designed to execute one or more of the method steps.

The method of the invention is intended for processing by recycling of a workpiece made of galvanized plastic, and is suitable and configured for this purpose.

Processing by recycling is understood here and hereinafter more particularly to mean division of a workpiece or recycling material consisting of multiple constituents into reusable materials (recyclate). A galvanized plastic is understood here and hereinafter more particularly to mean a plastic metallization, i.e. a coating of a material made of plastic with a metal layer (metal coating), where the metal layer has especially been applied to the plastic material by electrolytic deposition (electroplated layer).

The workpiece is, for example, an electroplated product or electroplated waste. The plastic, or the plastic material of the workpiece, is, for example, a thermoplastic, especially an acrylonitrile-butadiene-styrene (ABS) copolymer or a polyamide (PA) or an ABS and polycarbonate (PC). The electrolytic coating or the metal layer has especially been produced from copper (Cu), nickel (Ni) and/or chromium (Cr).

In the method, the workpiece is mechanically delaminated in a delamination process or a delamination step by means of a fragmentation unit using the electrohydraulic effect. Preference is given here to using a shockwave method in a liquid, for example in water or distilled water, in which delamination of the galvanized products or galvanized plastics is achieved by means of intense pressure waves, so-called shockwaves. “Delaminating” or “delamination” is understood to mean separation of the plastic material and the metal layer. This means that, in accordance with the invention, a shockwave method is used for delamination of a galvanized plastic.

The workpiece may take the form of a whole component or of a (pre)comminuted component (plastic fragments). The workpiece is preferably first comminuted into workpiece pellets (ground material) by means of a comminution apparatus in an upstream precomminution step before the shockwave treatment of the fragmentation unit. This assures homogenization of the workpiece material for the subsequent processing. The workpiece is comminuted, for example, to workpiece pellets having an average piece or grain size of less than 50 mm, especially less than 20 mm. This mechanical pretreatment or comminution step may in this case already bring about partial delamination of the plastic and the electroplated layer. In addition, the precomminution increases the efficiency of the fragmentation unit and of the shockwave treatment.

The fragmentation unit generates, as output material, a suspension of the liquid and plastic pellets and of coating pellets. In other words, the workpiece or workpiece pellets are divided by means of the fragmentation unit into plastic pellets and coating pellets. Plastic pellets are understood here and hereinafter more particularly to mean a plastic fraction or a plastic product including pellets and fragments. Correspondingly, coating pellets are understood here and hereinafter more particularly to mean a coating fraction or coating product comprising pellets and fragments. The coating pellets are composed here of magnetic pellet particles of the detached coating and of weakly magnetic pellet particles of plastic pellets with coating residues.

The shockwave treatment is followed, for example, by sieving to remove a metal-rich fines fraction; in addition, if required, it is possible to add a washing step in order to clean/rinse the surface of the plastics.

The output material from the fragmentation unit, i.e. the suspension, is then (pre)dewatered and, for example, dried. Thus, the liquid is removed from the suspension, such that essentially only the heterogeneous mixture or blend of the plastic pellets and coating pellets remains. Preliminary dewatering of the comminution product of the workpiece and optionally drying makes the blend material more easily sortable. The blend of the plastic pellets and coating pellets after the dewatering and optionally drying preferably has a residual moisture content of less than 10 m % (percent by mass), especially less than 5 m %.

By means of a magnetic separator, the plastic pellets are finally separated from the coating pellets by magnetic separation. In other words, the blend of plastic pellets and coating pellets is sorted. By means of a single-stage or multistage magnetic separation, the detached coating constituents that have not already been removed by the preliminary sieving are separated from the plastics. In addition, with the aid of the magnetic separation, it is also possible to efficiently separate out plastic fragments with remaining coating residues. In this way, a particularly suitable method is implemented.

As a result, a clean (nonmagnetic) plastic product or plastic pellets with a purity of greater than 99 m %, for example 99.9 m %, is achieved, and a highly magnetic product (detached coating) and a weakly magnetic product (plastic fragments with coating residues) are obtained. The plastic product or plastic pellets are dispensed, for example, in a dispensing station, especially by means of bulk bag dispensing.

The weakly magnetic product (plastic fragments with coating residues) can be sent again to the shockwave-based delamination process in the fragmentation unit.

Preferably, the plastic pellets or the recycled plastic has sufficiently high quality or sufficiently high cleanliness for direct recycling or direct reuse in production, and hence replacement or saving of virgin material or primary plastic. The plastic pellets have a purity, for example, of greater than 99 m %, especially greater than 99.9 m %. This means that the secondary plastic processed by the method of the invention essentially does not involve downcycling, and corresponds in qualitative terms to a primary plastic.

The inventive delamination of the workpiece by means of the electrohydraulic effect or by means of the shockwave method results in implementation of a particularly simple method of reduced complexity in which solely an electrical current and a mechanical pressure wave are used. There is thus no need in the method for any chemical and/or thermal method for removal of the coating.

The shockwave process results in merely slight mechanical stress on the plastics, which allows the piece size or grain size to be kept very substantially constant. In particular, only a very small proportion of fines fraction is formed during the delamination process. For example, the proportion of a fines fraction having a grain size of less than 1 mm is less than 10 m %, especially less than 5 m %, preferably less than 2 m %. Thus, the method of the invention ensures a narrow grain size distribution of the plastic pellets, which is advantageous as input for industrial processes.

The method also enables recycling of a utilizable metal fraction or a utilizable metal concentrate from the (electroplated/metal) coating of the workpiece, since the coating is not destroyed in the course of the method. In particular, a simple sorting methodology is implemented by means of the magnetic separator, since the residual composites (plastic fragments with coating residues) are weakly magnetic and hence can be separated out and recycled easily.

In one possible development, the liquid in the suspension is recycled into the fragmentation unit in the course of dewatering. This reduces the consumption of liquid in the fragmentation unit. The circulation of the (process) liquid (process water) which is implemented as a result continues until a limiting conductivity is attained. In other words, the liquid in the suspension is analyzed for electrical conductivity and compared with a recorded threshold or limit. If the value does not reach or go below the limit, the liquid is directed back into the fragmentation unit. If the value does reach or go below the limit, the liquid is disposed of, and a new liquid is introduced into the fragmentation unit. The limiting conductivity is, for example, less than 5 mS/cm (millisiemens per centimeter), especially less than 2 mS/cm.

In an additional or further aspect of the invention, the method is conducted automatically. This means that the workpiece material is guided continuously or batchwise, for example, from one method step to the next, and the method steps preferably proceed essentially parallel to one another. This achieves a high throughput for processing of the galvanized plastics.

The apparatus of the invention is intended for performance of the above-described method, and is suitable and set up for the purpose. The apparatus is specifically designed for processing by recycling of a material composed of galvanized plastic.

The apparatus has, for example, a comminution apparatus as pre-comminution of the workpiece into workpiece pellets. The comminution apparatus is designed here, for example, as a cutting mill, as a shredder, or as a crossflow shredder.

The apparatus has a fragmentation unit for electrohydraulic delamination of the workpiece or workpiece pellets. The workpiece is broken down here by means of shockwave treatment with (low) pulse energy to give plastic pellets and coating pellets. The workpiece or workpiece pellets are fed into the fragmentation unit, for example, by means of conveying technology (belts, suction conveyors).

The material output of the comminuted material from the fragmentation unit can be effected by means of a conveyor belt or a conveying screw, a water purge, an airlift pump or a combination thereof. The comminuted material or the pellets are suspended in a liquid in the fragmentation unit in the course of material discharge, and the resulting suspension is (pre)dewatered and, for example, dried by means of a dryer. The dryer here takes the form, for example, of a washing screen, of a (plastic) pellet dryer with hot air, of a fluidized bed dryer, of a centrifugal dryer, or a combination thereof. The starting material obtained in the dryer is essentially a heterogeneous blend of the plastic pellets and the coating pellets. The blend here preferably has a residual moisture content of less than 10 m %, especially less than 5 m %.

The dried blend is fed into a magnetic separator that sorts the blend by magnetic separation into the plastic pellets and the coating pellets. The magnetic separator, which has one or more stages for example, is designed here as a magnetic drum or as a strip magnet. The magnetic separator here especially has a magnetic field strength between 1,000 G (gauss) and 25,000 G.

This achieves a particularly suitable apparatus for processing of workpieces composed of galvanized plastic. The apparatus here preferably has a throughput of 50 kg/h (kilograms/hour) to 500 kg/h of starting material (workpiece, workpiece pellets).

In a suitable configuration, the fragmentation unit has a comminution reactor for the shockwave treatment of the workpiece. The comminution reactor here has a vessel (comminution vessel) filled with a liquid, for example water and a pulsed current source. The pulsed current source is guided into the vessel by means of at least two electrodes immersed in the liquid. One of the electrodes is designed here, for example, as a ground electrode, while the other electrode is designed as a high-voltage electrode. An underwater spark zone is formed between the electrodes, and the electrodes in operation generate a shock discharge in the liquid by means of high-voltage pulses. The workpiece or workpiece pellets are guided here through the underwater spark zone. Optionally, closure of the comminution reactor with a process-stable flap is possible, which allows a dwell time of the material to be comminuted in the comminution vessel to be adjusted as desired or universally.

The parameters of the shock discharge, especially a pulse energy or discharge energy, the magnitude of the high voltage between the electrodes, a repetition frequency of the high-voltage pulses and/or the arrangement of the electrodes, are chosen in the fragmentation unit such that there is separation of the galvanic coating from the plastic. In a preferred configuration, the working voltage is, for example, between 25 kV and 50 kV, where the pulse energy or discharge energy of the shock discharge is less than 50 J, for example between 2 J and 50 J. A pulse sequence frequency is in the range, for example, of 10 to 50 discharges per second, while the electrode separation is, for example, 5 mm to 40 mm.

In a suitable design, the pulsed current source has at least one electrode stack having three to four (high-voltage) electrodes arranged in series or in succession in a conveying direction. The pulsed current source preferably has one or more electrode stacks each having three to four electrodes working in parallel and each having one to four measurement electrodes. The electrode stacks may be readjusted here for closed-loop process control by means of an (adjustable) cylinder during the shockwave process. In other words, an adjustment of distance, i.e. a change in the distances between the electrode stacks or the electrodes, is possible. This ensures reliable delamination of the workpiece or of the workpiece pellets. For scaling, for example, the number of pulsed current sources and/or electrode stacks is varied.

In an additional or further aspect of the invention, the fragmentation unit has a comminution container that accommodates the comminution reactor.

In particular, a sound protection cabin and/or an EMC protection cabin of the fragmentation unit are designed in a container design. This ensures a simple and inexpensive construction of the fragmentation unit.

The workpiece or workpiece pellets can be fed in here, for example, laterally or via a roof of the comminution container. For this purpose, the roof has, for example, a (filling) port or an opening. The workpiece is suitably positioned in or fed into the comminution reactor here directly under gravity to each electrode stack, a group interconnection composed of three to four high-voltage electrodes, between two adjacent electrode stacks or centrally. As a result, the workpiece to be delaminated is introduced directly into the region having the highest pressure gradients, such that reliable delamination is assured.

According to the invention, the electrohydraulic effect is used for delamination of a workpiece composed of galvanized plastic by means of shockwave treatment. The details given in connection with the method and/or the apparatus are also applicable mutatis mutandis to the use, and vice versa.

Other features which are considered as characteristic for the invention are set forth in the appended claims.

Although the invention is illustrated and described herein as embodied in a method for processing, by means of recycling, a workpiece made of electroplated plastic, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic view of an apparatus for processing by recycling of a workpiece composed of galvanized plastic in a first embodiment according to the invention;

FIG. 2 is a perspective view of a fragmentation unit of the apparatus in a first embodiment;

FIG. 3 is a perspective view of a fragmentation unit of the apparatus in a second embodiment; and

FIG. 4 is a schematic diagram of the apparatus in a second embodiment.

### DETAILED DESCRIPTION OF THE INVENTION

Mutually corresponding parts and parameters are always given the same reference numerals in all the figures.

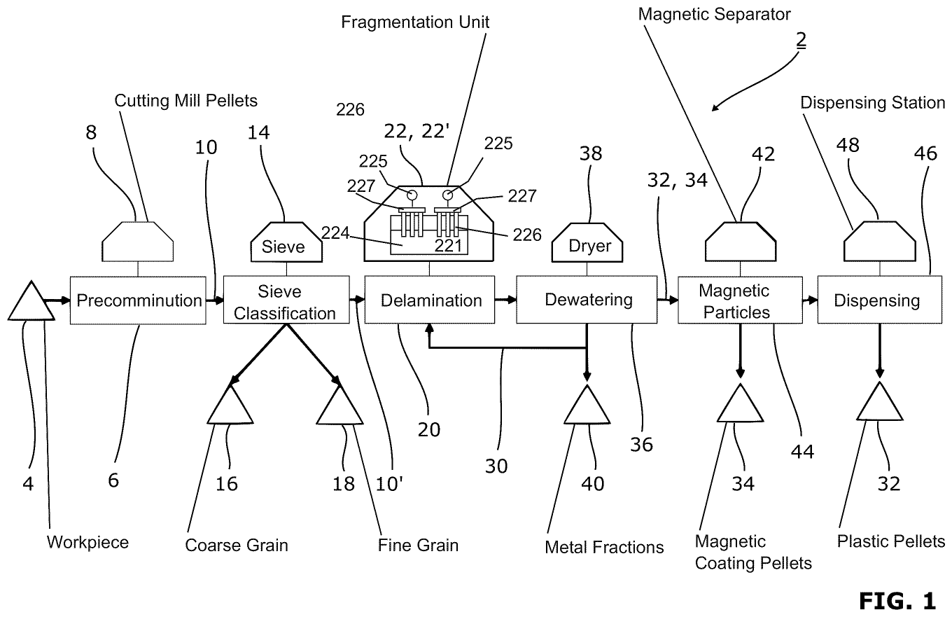

Referring now to the figures of the drawings in detail and first, particularly to FIG. 1 thereof, there is shown a schematic and simplified view of an apparatus 2. The apparatus 2 is designed as a processing plant for processing by recycling of a workpiece 4 composed of galvanized plastic. The plant design shown in FIG. 1 is configured here, for example, for an automatic throughput of 100 kg/h of starting material. This means that, by means of the apparatus, 100 kg of workpieces 4 per hour can be processed automatically, continuously or batchwise. The details that follow are based by way of example on just a single workpiece 4.

The workpiece 4 here is, in particular, electroplated waste or a galvanized plastic composed of ABS plastic with a coating of chromium, nickel and/or copper.

The apparatus 2 here has six process steps or method steps for processing. In a first method step, which is also referred to hereinafter as precomminution 6, the workpiece 4 is comminuted by means of a cutting mill 8 to give material pellets 10. This achieves homogenization of the starting material for a subsequent shockwave treatment. The workpiece pellets 10 here have an average grain size, for example, of less than 20 mm.

The cutting mill 8 is configured, for example, for comminution into workpiece pellets 10 having an average grain size of less than 20 mm. The cutting mill 8 here has, for example, two rows of rotor blades for comminution.

For further processing, the material pellets 10 preferably have a narrow grain size distribution with an upper grain size limit and a lower grain size limit. In a second method step, also referred to hereinafter as sieve classification 12, the workpiece pellets 10 are therefore sieved by means of a sieve system 14. For example, the sieve system 14 is designed as a linear vibrating sieve or as a round sieve/tumbler sieve. By means of the sieve system 14, coarse grains 16 and fine grains 18 are sieved out of or removed from the workpiece pellets 10. Fine grains 18 are understood to mean pellet particles having a grain size less than the lower grain size limit, for example less than 1 mm. Coarse grains 16 are correspondingly understood to mean pellet particles having a grain size greater than the lower grain size limit, for example greater than 10 mm. As a result, the sieved workpiece pellets 10′ have a grain size distribution, for example, between 1 mm and 10 mm.

The sieved workpiece pellets 10′, in a method step referred to as delamination 20, are sent to a fragmentation unit or shockwave system 22.

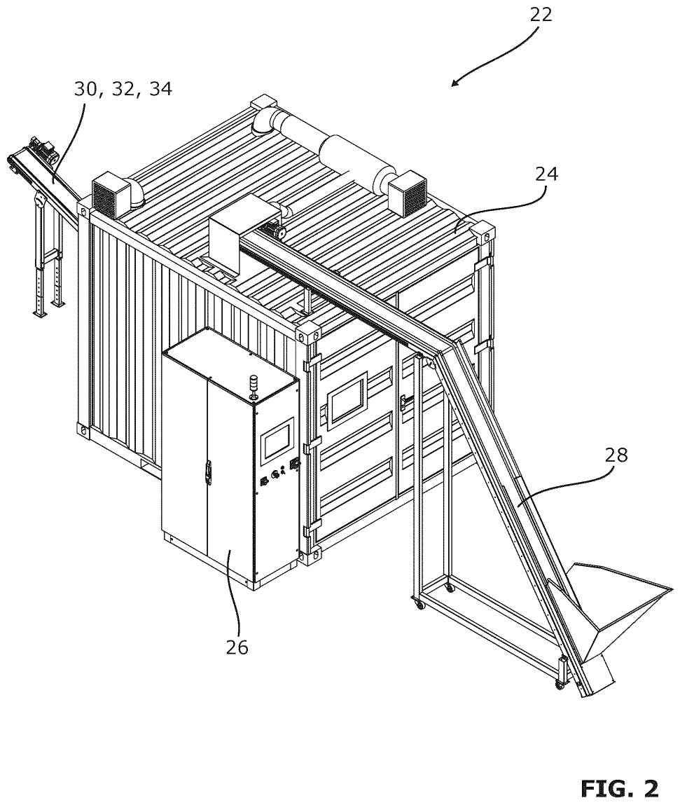

The fragmentation unit 22 is shown individually in FIG. 2. The fragmentation unit 22 is provided here for delamination of the workpiece pellets 10′ by means of the electrohydraulic effect, and is suitable and intended for the purpose. In particular, the fragmentation unit 22 is suitable and set up for continuous shockwave treatment with low pulse energy.

The fragmentation unit 22 here has a comminution reactor 221 for the delamination of the workpiece pellets 10′ by means of a shockwave treatment. The comminution reactor 221 here has a vessel (comminution vessel) filled with a liquid 224, for example water, and at least one pulsed current source 225. The pulsed current source 225 is guided into the vessel by means of at least two electrodes 226 immersed in the liquid 224. One of the electrodes 226 here is designed, for example, as a ground electrode, while the other electrode is designed as a high-voltage electrode. The pulsed current source 225 preferably supplies three to four (high-voltage) electrodes, arranged as electrode stacks 227. The fragmentation unit 22 has, for example, a number of pulsed current sources 225 that in turn each supply one or more electrode stacks 227 each having three to four high-voltage electrodes 226. The electrode stacks 227 may be readjusted here for closed-loop process control by means of an (adjustable) cylinder during the shockwave process.

The fragmentation unit 22 here has a comminution reactor (not shown in detail) for the delamination of the workpiece pellets 10′ by means of a shockwave treatment. The comminution reactor here has a vessel (comminution vessel) filled with a liquid, for example water, and at least one pulsed current source. The pulsed current source is guided into the vessel by means of at least two electrodes immersed in the liquid. One of the electrodes here is designed, for example, as a ground electrode, while the other electrode is designed as a high-voltage electrode. The pulsed current source preferably supplies three to four (high-voltage) electrodes, arranged as electrode stacks. The fragmentation unit 22 has, for example, a number of pulsed current sources that in turn each supply one or more electrode stacks each having three to four high-voltage electrodes. The electrode stacks may be readjusted here for closed-loop process control by means of an (adjustable) cylinder during the shockwave process.

Variation of the pulsed current sources and/or the number of high-voltage electrodes enables simple and suitable scaling of the fragmentation unit 22 with regard to a desired throughput.

An underwater spark zone is formed between the electrodes, and the electrodes in operation, by means of high-voltage pulses, generate a shock discharge in the liquid that delaminates the workpiece pellets 10′. The workpiece pellets 10′ here are guided through the underwater spark zone.

The parameters of the shock discharge, especially a pulse energy or discharge energy, the magnitude of the high voltage between the electrodes, a repetition frequency of the high-voltage pulses and/or the arrangement of the electrodes, in the fragmentation unit are chosen such that the electroplated coating is separated from the plastic. In a preferred configuration, the high voltage is less than 50 kV, and the pulse energy or discharge energy of the shock discharge is less than 50 J, for example between 5 J and 50 J.

The comminution reactor is housed in a comminution container 24 as sound protection encapsulation. The sound level during operation of the fragmentation unit is preferably less than 85 dB(A). A control cabinet 26 accommodating control electronics, for example a programmable logic controller (PLC), for the at least one pulsed current source is disposed adjacent to the comminution container 24. The pulsed current source or a (pulsed current) generator is accommodated in a generator cabinet (not shown in detail), which is disposed separately from the control cabinet 26.

The fragmentation unit 22 has a conveying device 28 designed as a suction conveyor for material supply, which guides the workpiece pellets 10′ via a ramp to an opening in the roof of the comminution container 24. The workpiece pellets 10′ here are suitably positioned in or fed into the comminution reactor directly under gravity to each electrode stack, a group interconnection composed of three to four high-voltage electrodes, between two adjacent electrode stacks or centrally. As a result, the workpiece pellets 10′ to be delaminated are introduced directly into the region having the highest pressure gradients, such that reliable delamination is assured.

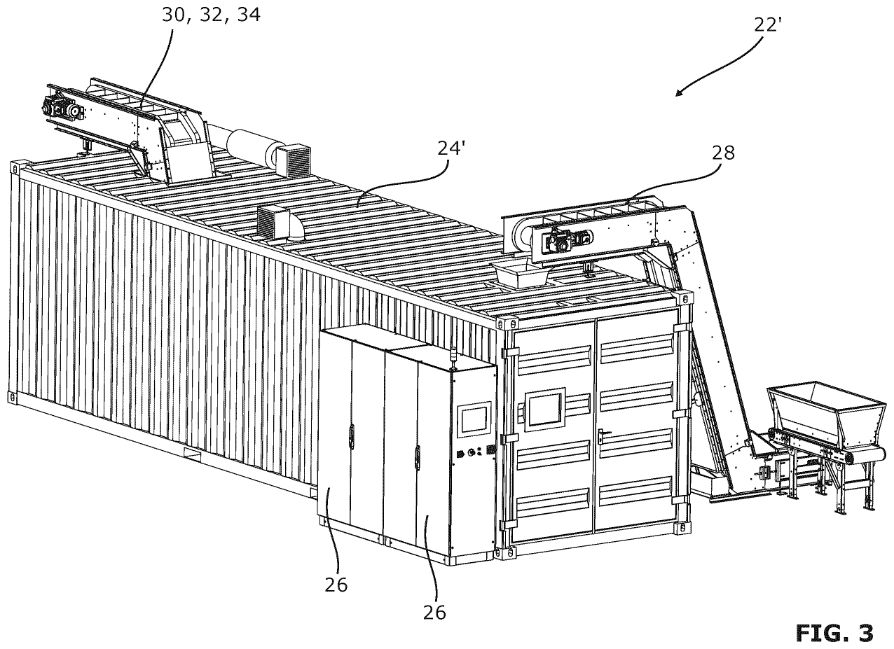

FIG. 3 shows a second embodiment of the fragmentation unit 22′.

The fragmentation unit 22′ here, by comparison with the embodiment described above, has a larger comminution container 24′. For example, the comminution container 24′ is four times larger than the comminution container 24. In one conceivable set of dimensions, the comminution container 24 is designed as a 10-foot container, in which case the comminution container 24′ is designed as a 40-foot container. The 10-foot container has, for example, a throughput of 100 kg/h, while the 40-foot container has especially about 500 kg/h as throughput. The fragmentation unit 22′ has, for example, two control cabinets 26. The conveying device 28 of the fragmentation unit 22′ is designed, for example, as a conveyor belt.

The material output of the comminuted material from the fragmentation unit 22, 22′ can be effected by means of a conveyor belt or a conveying screw, a water purge, an airlift pump or a combination of these.

The fragmentation unit 22 produces a suspension as output material. The suspension here is composed of the liquid 30 from the comminution reactor and the delaminated constituents 32, 34 of the workpiece pellets 10′. In particular, the suspension here comprises plastic pellets 32, i.e. pellets of the polymer constituents, and coating pellets 32, i.e. pellets of metal fragments of the electroplated coating and plastic pellets with a residual coating.

The suspension is dewatered and dried by means of a dryer 38 in a subsequent process step, which is also referred to hereinafter as drying and dewatering 36. In the dewatering 36, the liquid 30 is separated from the solid constituents 32, 34. There is preferably a sieving operation here for removal of a metal-rich fines fraction of the coating pellets 34; in addition, a washing step can also be added if required. The fines fraction is formed here by metal fractions 40, i.e. by metallic fragments of the electroplated coating that have a particle size of less than 1 mm.

The downstream drying/dewatering zone of the drying and dewatering 36 has, for example, a centrifuge to establish a residual moisture content of less than 5 m %. For this purpose, the dryer 38 is designed, for example, as a centrifugal dryer that separates the liquid 30 from the constituents 32, 34 by means of centrifugal dewatering. Appropriately, the dryer 38 has a sieve drum for integrated removal of the residual fines content and of the metal fractions 40.

Alternatively, the dryer 38 may also be designed as a dewatering sieve. The dryer 38 here is especially designed as a linear vibrating sieve with three segments. The first segment has integrated wash nozzles for cleaning. In the second segment, there is a sieving and preliminary dewatering operation for removal of all particles smaller than 2 mm. In the third segment, the pellets 32, 34 are dried by means of a hot air blower.

The third segment for hot air drying may also be designed as a separate linear vibrating sieve. This means that the first two segments of the dryer 38 are disposed in a dedicated vibrating sieve for dewatering, and the third segment of the dryer 38 in a separate linear vibrating sieve with hot air drying.

The starting material from the drying and dewatering 36 is a heterogeneous blend of the plastic pellets 32 and the coating pellets 34. The blend here preferably has a residual moisture content of less than 10 m %, especially less than 5 m %.

The liquid 30 removed from the dryer 38 in the course of dewatering is preferably recycled back into the fragmentation unit. For this purpose, the liquid first passes through a wastewater treatment operation for separation of solids. In this regard, an otherwise unspecified solids separator is provided, by means of which coarse and fine-particulate constituents, for example the metal fraction 40, are separated from the liquid. The solids separator is designed, for example, as an inclined filter or vacuum band filter. The liquid 30 is disposed of and replaced by new liquid when a limiting conductivity is attained.

The dried blend, in a method step referred to as separation of magnetic particles 44, is separated by means of a magnetic separator 42 into the non-magnetic plastic pellets 32 and the (at least partly) magnetic coating pellets 34. In other words, the dried blend is fed into the magnetic separator 42, which separates the blend by magnetic separation into a magnetic fraction consisting of detached coating and plastic pellets with residual coating (coating pellets 34), and a nonmagnetic fraction of the plastic pieces (plastic pellets 32) with a purity of greater than 99 m %.

The single-stage or multistage magnetic separator 42 is configured here, for example, as a magnetic drum or as an (over)band magnet. The magnetic separator here especially has a magnetic field strength between 3,500 G and 20,000 G. The blend is fed in here, for example, via a vibrating channel, and there is continuous removal of magnetic particles such as detached metallization and pellets with residual coating.

Removed pellets with residual coating in the coating pellets 34 are preferably recycled here to the fragmentation unit 22, and the metallic pellets of the coating pellets 34 are further processible as recycling material.

The clean (nonmagnetic) plastic product or plastic pellets 32 has a purity of greater than 99 m %, for example 99.9 m %. The plastic pellets 32 are then dispensed with a dispensing station 48 in a method step referred to as dispensing 46. In particular, the plastic pellets 32 are dispensed here into bulk bags.

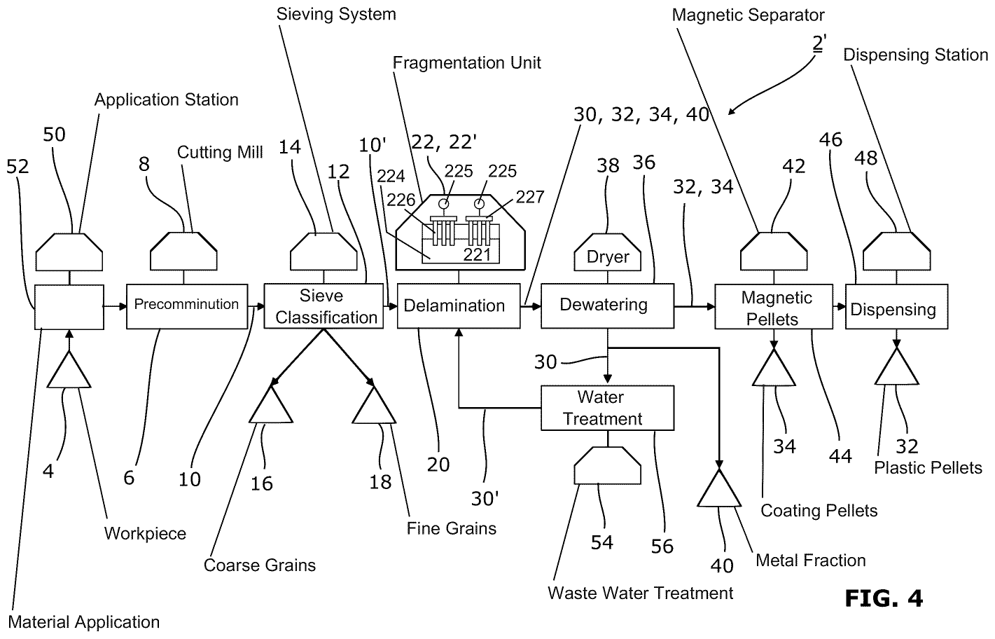

The apparatus 2′ shown in FIG. 4 corresponds essentially to the above-described design, except that an application station 50 for material application 52 of the workpiece 4 is additionally provided upstream of the precomminution 6.

The apparatus 2′ also has an optional wastewater treatment 54 for process water treatment 56, which separates the dissolved constituents out of the liquid 30 from the dryer 38 and hence makes a processed or cleaned liquid 30′ suitable for introduction into a sewer. The liquid 30′ is returned here to the fragmentation unit 22, 22′.

The invention is not limited to the working examples described above. Instead, it is also possible for other variants of the invention to be inferred therefrom by a person skilled in the art without departing from the subject matter of the invention. In particular, moreover, all individual features described in connection with the working examples are also combinable with one another in other ways without departing from the subject matter of the invention.

The following is a summary list of reference numerals and the corresponding structure used in the above description of the invention.

### LIST OF REFERENCE NUMERALS

2, 2′ apparatus
4 workpiece
6 precomminution
8 cutting mill
10, 10′ workpiece pellets
12 sieve classification
14 sieving system
16 coarse grains
18 fine grains
20 delamination
22 fragmentation unit
221 comminution reactor
224 liquid
225 pulsed current source
226 electrode
227 electrode stack
24, 24′ comminution container
26 control cabinet
28 conveying device
30, 30′ liquid
32 plastic pellets
34 coating pellets
36 drying and dewatering
38 dryer
40 metal fraction
42 magnetic separator
44 separation of magnetic particles
46 dispensing
48 dispensing station
50 application station
52 material application
54 wastewater treatment
56 process water treatment

1. A processing method for recycling a workpiece composed of galvanized plastic, which comprises the steps of:
delaminating the workpiece by means of a fragmentation unit by employing a electrohydraulic effect to give a suspension formed of plastic pellets and coating pellets;
dewatering the suspension; and
using a magnetic separator to separate the plastic pellets from the coating pellets by magnetic separation.

2. The method according to claim 1, wherein the plastic pellets have a purity sufficient for direct recycling or direct reuse in a production of galvanized plastics.

3. The method according to claim 2, wherein the plastic pellets have a purity of greater than 99 m %.

4. The method according to claim 1, which further comprises comminuting the workpiece into workpiece pellets before being fed into the fragmentation unit.

5. The method according to claim 1, which further comprises recycling a liquid from the suspension into the fragmentation unit in a course of the dewatering.

6. The method according to claim 5, which further comprises conducting the method automatically.

7. An apparatus for recycling a workpiece composed of galvanized plastic, the apparatus comprising:
a fragmentation unit for electrohydraulic delamination of the workpiece;
a dryer for dewatering a suspension which comes from the fragmentation unit, the suspension containing plastic pellets and coating pellets; and
a magnetic separator for magnetic separation of the plastic pellets from the coating pellets.

8. The apparatus according to claim 7, wherein:
said fragmentation unit has a comminution reactor having a vessel filled with a liquid and a pulsed current source with at least two electrodes immersed in the liquid, between which an underwater spark zone is formed, and which generates a shock discharge in the liquid by means of high-voltage pulses; and
the workpiece is passed through the underwater spark zone.

9. The apparatus according to claim 8, wherein said pulsed current source has at least one electrode stack having three to four said electrodes.

10. The apparatus according to claim 9, wherein a number of pulsed current sources and/or a number of electrode stacks is scalable.

11. The apparatus according to claim 8, wherein a pulse energy or discharge energy of the shock discharge is less than 50 J at a high voltage of less than 50 kV.

12. The apparatus according to claim 8, wherein said fragmentation unit has a comminution container that accommodates said comminution reactor.

13. The apparatus according to claim 12, wherein the workpiece is fed in via a roof of said comminution container in such a way that the workpiece is positioned directly in front of said electrodes of said comminution reactor under a force of gravity.

14. A delamination process, which comprises the steps of:
using an electrohydraulic effect for delamination of a workpiece composed of galvanized plastic by means of a shockwave treatment.
